(19) United States
(12) Patent Application Publication
(10) Pub. No.: US 2011/0222384 A1
(43) Pub. Date: Sep. 15, 2011

(54) OPTICAL DISC DEVICE AND OPTICAL DISC DEVICE DRIVE METHOD

(76) Inventors: Kenji Kondo, Osaka (JP); Takashi Kishimoto, Nara (JP); Kenji Fujiune, Osaka (JP)

(21) Appl. No.: 12/673,991

(22) PCT Filed: Jun. 19, 2009
(86) PCT No.: PCT/JP2009/002796

§ 371 Date: Feb. 18, 2010

(30) Foreign Application Priority Data
Jun. 19, 2008 (JP) 2008-159976

(51) Int. Cl. G11B 27/36

(52) U.S. Cl. 369/53.2; G9B/27.052

(57) ABSTRACT

An optical disc apparatus of the present invention records and/or reproduces data to/from an optical disc where data is recorded on one of a groove track and a land track. The optical disc apparatus includes an identification section for identifying the type of the optical disc as being either an optical disc where data is recorded or reproduced to/from a groove track or an optical disc where data is recorded or reproduced to/from a land track. The identification section identifies the type of the optical disc while in a state where a focus control is being performed and a tracking control is not being performed.

### TECHNICAL FIELD

The present invention relates to a disc apparatus for recording or reproducing information to/from optical discs (including various optical discs such as read-only discs and write-and-read discs) by using laser light, or the like, and more particularly to an optical disc apparatus having a function of identifying the tracking polarity of an optical disc.

### BACKGROUND ART

DVD discs (hereinafter referred to as “DVDs”) have been widespread as optical discs having a high recording density on which a large amount of digital information can be recorded. Blu-ray discs (hereinafter referred to as “BDs”) having an even higher recording density have also been proposed, and among others, BD-Rs and BD-REs using a phase-change material in the recording film have been in use as recordable BDs.

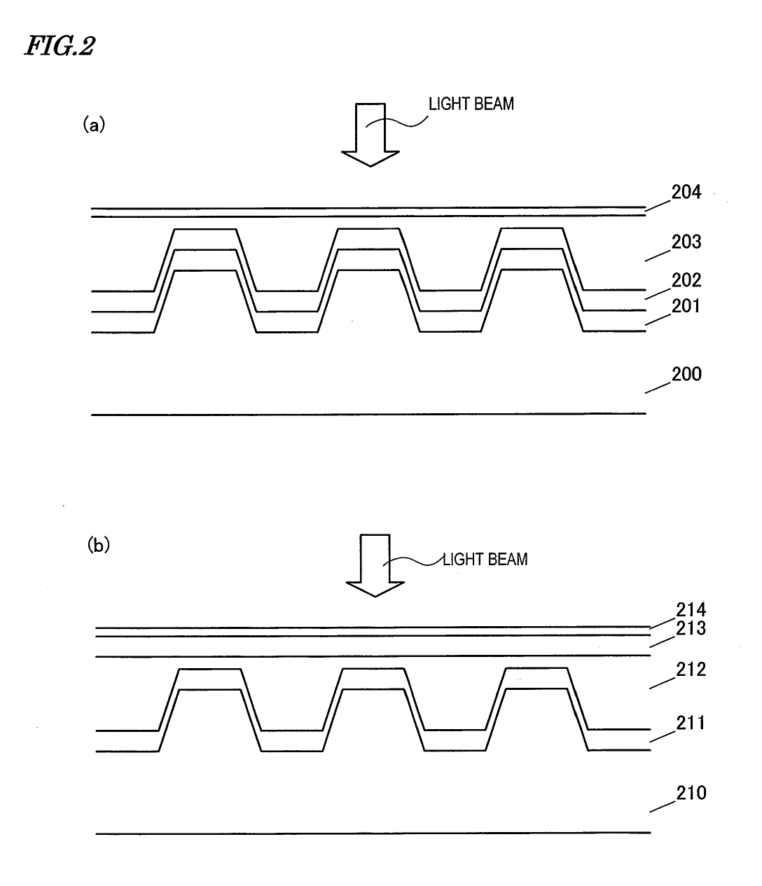

Herein, the structure and the deposition method of a BD-R disc will be described with reference to FIG. 2(a).

FIG. 2(a) is a schematic diagram showing a cross section of a BD-R disc. A BD-R disc includes a substrate 200 formed by injection molding, a reflective layer 201 formed thereon by sputtering, or the like, a recording layer 202 formed thereon by a vapor deposition method, and a sheet 204 bonded thereto via an adhesive layer 203 therebetween. Note that where a groove track is one of the depressed portion and the protruding portion of the substrate 200 that is closer to the optical pickup (optical head) from which an optical beam is output, and a land track is the one that is farther away from the optical pickup, data is recorded on the groove track in a BD-R disc.

In recent years, a BD-R disc has been proposed and has been in use, in which a recording film is formed by a spin-coating method using an organic pigment as the recording film material in order to reduce the cost of the disc. Due to the characteristics of the recording film thereof, this disc has characteristics such that the reflectance increases as data is recorded and is called a Low-to-High disc (hereinafter referred to as an “LTH disk”). On the other hand, the conventional BD-Rs and BD-REs described above have characteristics such that the reflectance decreases as data is recorded and are therefore called “High-to-Low discs” (hereinafter referred to as “HTL discs”).

Herein, the structure and the deposition method of an LTH disc will be described with reference to FIG. 2(b).

FIG. 2(b) is a schematic diagram showing a cross section of an LTH disc. An LTH disc includes a substrate 210 formed by injection molding, a reflective layer 211 formed thereon by sputtering, or the like, a recording layer 212 formed thereon by a spin-coating method, and a sheet 214 bonded thereto via an adhesive layer 213 therebetween. Note that where a groove track is one of the depressed portion and the protruding portion of the substrate 210 that is closer to the optical pickup from which an optical beam is output, and a land track is the one that is farther away from the optical pickup, as in FIG. 2(a), data is preferably recorded on the land track in an LTH disc. That is, since a recording layer needs to have a predetermined thickness, it is necessary to increase the thickness of the groove track in order to record data on the groove track, which means an increase in the material cost. Therefore, with LTH discs, which aim at a low cost, data is recorded on the land track.

As described above, there are two types of BDs, i.e., discs that record data on the groove track and discs that record data on the land track. Therefore, an optical disc apparatus that handles BDs is required to determine whether the inserted disc is a disc of the groove track recording type or a disc of the land track recording type, and to perform a tracking control with a tracking polarity according to the determination.

With a disc where data is recorded or reproduced to/from the groove track, a tracking control is performed such that the light beam spot follows the groove track. With a disc where data is recorded or reproduced to/from the land track, a tracking control is performed such that the light beam spot follows the land track. The tracking servo signal polarity is different between when a tracking control is performed on the groove track and when a tracking control is performed on the land track. Therefore, the expression “to identify the tracking polarity” is used herein to mean to identify whether a disc is one where data is recorded or reproduced to/from the groove track or one where data is recorded or reproduced to/from the land track. Note that assuming that a land and a groove are a pair, the terms “land polarity” and “groove polarity” may also be used. An example of how to identify the tracking polarity will be described below.

First, in a control data area or a BCA (Burst Cutting Area) area of a BD, tracking polarity information is recorded, which indicates whether the disc is a disc where data is recorded on the groove track or a disc where data is recorded data on the land track. By utilizing this, by reproducing the tracking polarity information recorded on the disc upon the apparatus start-up, it is possible to identify the tracking polarity.

Upon the apparatus start-up, a tracking pull-in operation may be performed for one tracking polarity so that it is determined that the tracking polarity is correct when the recorded address information can be reproduced, whereas it is determined that the other tracking polarity is correct when it cannot be reproduced (see, for example, Patent Document 1).

Alternatively, the tracking polarity identification can be performed by the following procedure.

First, upon the apparatus start-up, a tracking pull-in operation is performed with a polarity that is tuned for the groove track (the groove polarity) to thereby perform a tracking control on the groove track. In this state, the address reading percentage for a certain number of tracks is measured. Then, a tracking pull-in operation is performed after the polarity is switched to one that is tuned for the land track (the land polarity), and the address reading percentage for the certain number of tracks is measured as in the measurement for the groove polarity. Based on the reading results for the opposite polarities, it is determined that the tracking polarity with fewer errors is the correct one, and the tracking control is thereafter performed with the determined polarity.

### CITATION LIST

### Patent Literature

[Patent Document 1] International Publication WO2006/006458 pamphlet

### SUMMARY OF INVENTION

### Technical Problem

However, the above tracking polarity identification method has the following problems.

First, since the identification is made based on measurement results obtained by performing a tracking control on the land and on the groove, it takes time, thereby increasing the start-up time of the apparatus.

Moreover, since the tracking polarity identification requires a tracking control to be performed on the land and on the groove, it is necessary in advance to perform various learning processes for both tracking polarities. This means, at the start-up of the apparatus, it takes more time before the tracking polarity identification is started, thereby increasing the start-up time of the apparatus.

An LTH disc described above, by the standard, has a higher degree of groove modulation as compared with an HTL disc, and therefore has a higher degree of modulation of the tracking error signal by the push-pull method. This means that when an astigmatism method is used for the focus error signal, there will be a large amount of optical crosstalk, i.e., the push-pull tracking error signal leaking into the focus error signal. When there is an optical crosstalk, the light spot is fluctuated by the focus control in the direction vertical to the information layer of the optical disc (this direction will hereinafter be referred to as the “focus direction”), and the focus control may come out of focus if the fluctuation is large. Moreover, when the optical crosstalk is large, the actuator driving current for use in the focus control will also be large, and the heat generated by the large driving current will adversely influence the actuator.

The present invention has been made to solve these problems, and provides an optical disc apparatus for identifying the tracking polarity with the focus control ON and the tracking control OFF.

### Solution to Problem

An optical disc apparatus of the present invention is an optical disc apparatus for recording and/or reproducing data to/from an information carrier where data is recorded on one of a groove track and a land track, comprising: a light-receiving section for receiving reflected light from the information carrier; a detection section for detecting, based on an output signal from the light-receiving section, a positional shift between a position where the information carrier is irradiated with a light beam and the track; and an identification section for identifying a type of the information carrier as being either an information carrier where data is recorded or reproduced to/from a groove track or an information carrier where data is recorded or reproduced to/from a land track, wherein the identification section identifies the type of the information carrier while in a state where a focus control is being performed and a tracking control is not being performed.

In one embodiment, the identification section identifies the type of the information carrier based on a signal generated as the light beam crosses the track while in a state where the tracking control is not being performed.

In one embodiment, the optical disc apparatus further comprises: a focus error signal generation section for generating a focus error signal indicating a state of convergence of the light beam based on the output signal from the light-receiving section; and a focus control section for outputting a signal for the focus control based on the focus error signal, wherein the identification section identifies the type of the information carrier based on a magnitude of an amplitude of an output signal from the focus control section.

In one embodiment: the detection section generates a push-pull tracking error signal and a differential phase ditection tracking error signal; and the identification section identifies the type of the information carrier based on a phase relationship between the push-pull tracking error signal and the differential phase ditection tracking error signal.

In one embodiment, the optical disc apparatus further comprises a focus error signal generation section for generating a focus error signal indicating a state of convergence of the light beam based on the output signal from the light-receiving section, wherein: the detection section generates a differential phase ditection tracking error signal; and the identification section identifies the type of the information carrier based on a phase relationship between a component of the focus error signal and the differential phase ditection tracking error signal.

In one embodiment, the detection section generates a tracking error signal; the optical disc apparatus further comprises a light amount detection section for detecting an amount of return light of the light beam based on the output signal from the light-receiving section; and a normalization section for normalizing the tracking error signal with an output signal from the light amount detection section; and the identification section identifies the type of the information carrier based on a magnitude of an amplitude of the normalized tracking error signal.

In one embodiment, the optical disc apparatus further comprises a light amount detection section for detecting an amount of return light of the light beam based on the output signal from the light-receiving section, wherein the identification section identifies the type of the information carrier based on a level of an output signal from the light amount detection section.

In one embodiment, the optical disc apparatus further comprises: a focus error signal generation section for generating a focus error signal indicating a state of convergence of the light beam based on the output signal from the light-receiving section; a focus control section for outputting a signal for the focus control; and a correction section for correcting an optical crosstalk contained in the focus error signal, wherein: the correction section performs the correction based on an identification result of the identification section; and the focus control section outputs a signal for the focus control based on the corrected focus error signal.

In one embodiment, the optical disc apparatus further comprises a setting section for setting a focus loop gain for the focus control, wherein if the identification section identifies the type of the information carrier as being an information carrier where data is recorded or reproduced to/from a land track, the setting section lowers the focus loop gain from that before the identification.

In one embodiment, the optical disc apparatus further comprises a setting section for setting a focus loop gain for the focus control, wherein if the identification section identifies the type of the information carrier as being an information carrier where data is recorded or reproduced to/from a groove track, the setting section raises the focus loop gain from that before the identification.

A method for driving an optical disc apparatus of the present invention is a method for driving an optical disc apparatus for recording and/or reproducing data to/from an information carrier where data is recorded on one of a groove track and a land track, the method comprising: receiving reflected light from the information carrier; detecting, based on a signal obtained by receiving the light, a positional shift between a position where the information carrier is irradiated with a light beam and the track; and identifying a type of the information carrier as being either an information carrier where data is recorded or reproduced to/from a groove track or an information carrier where data is recorded or reproduced to/from a land track, wherein the type of the information carrier is identified while in a state where a focus control is being performed and a tracking control is not being performed.

An integrated circuit of the present invention is an integrated circuit for identifying a type of an information carrier, when provided in an optical disc apparatus for recording and/or reproducing data to/from the information carrier, the integrated circuit comprising: a detection section for detecting a positional shift between a position where the information carrier is irradiated with a light beam and a track; and an identification section for identifying a type of the information carrier as being either an information carrier where data is recorded or reproduced to/from a groove track or an information carrier where data is recorded or reproduced to/from a land track, wherein the identification section identifies the type of the information carrier while in a state where a focus control is being performed and a tracking control is not being performed.

### Advantageous Effects of Invention

According to the present invention, the type of an optical disc is identified while in a state where a focus control is being performed and a tracking control is not being performed. Since it is then possible to identify the type of an optical disc without performing a tracking pull-in operation, it is possible to shorten the identification time and to thereby shorten the start-up time of an optical disc apparatus.

In one embodiment of the present invention, the type of an optical disc is identified based on a signal generated as the light beam crosses the track while in a state where a tracking control is not being performed. Since it is then possible to identify the type of an optical disc without performing a tracking pull-in operation, it is possible to shorten the identification time and to thereby shorten the start-up time of an optical disc apparatus.

In one embodiment of the present invention, the type of an optical disc is identified based on a magnitude of an amplitude of an output signal from the focus control section. Since it is then possible to identify the type of an optical disc without performing a tracking pull-in operation, it is possible to shorten the identification time and to thereby shorten the start-up time of an optical disc apparatus.

In one embodiment of the present invention, the type of an optical disc is identified based on a phase relationship between the push-pull tracking error signal and the differential phase ditection tracking error signal. Since it is then possible to identify the type of an optical disc without performing a tracking pull-in operation, it is possible to shorten the identification time and to thereby shorten the start-up time of an optical disc apparatus.

In one embodiment of the present invention, the type of an optical disc is identified based on a phase relationship between a component of the focus error signal and the differential phase ditection tracking error signal. Since it is then possible to identify the type of an optical disc without performing a tracking pull-in operation, it is possible to shorten the identification time and to thereby shorten the start-up time of an optical disc apparatus.

In one embodiment of the present invention, the type of an optical disc is identified based on a magnitude of an amplitude of a tracking error signal normalized with an output signal from the light amount detection section for detecting the amount of return light of the light beam. Since it is then possible to identify the type of an optical disc without performing a tracking pull-in operation, it is possible to shorten the identification time and to thereby shorten the start-up time of an optical disc apparatus.

In one embodiment of the present invention, the type of an optical disc is identified based on a level of an output signal from the light amount detection section for detecting the amount of return light of the light beam. Since it is then possible to identify the type of an optical disc without performing a tracking pull-in operation, it is possible to shorten the identification time and to thereby shorten the start-up time of an optical disc apparatus.

In one embodiment of the present invention, a signal for the focus control is output based on a focus error signal of which the optical crosstalk has been corrected based on the disc identification result. Even when using an LTH disc which has a higher degree of groove modulation, it is possible to prevent a focus driving current from being generated due to an optical crosstalk component and prevent the focus control from being fluctuated due to optical crosstalk, and it is therefore possible to reduce the power consumption and improve the stability of the focus control, thereby improving the recording/reproduction performance of the optical disc apparatus.

In one embodiment of the present invention, if the type of an optical disc is identified as being an optical disc where data is recorded or reproduced to/from a land track, the focus loop gain is lowered from that before the identification. By lowering the focus loop gain when using an LTH disc which has a higher degree of groove modulation, it is possible to reduce the generation of a focus driving current due to an optical crosstalk component and the fluctuation of the focus control due to optical crosstalk, and it is therefore possible to reduce the power consumption and improve the stability of the focus control, thereby improving the recording/reproduction performance of the optical disc apparatus.

In one embodiment of the present invention, if the type of an optical disc is identified as being an optical disc where data is recorded or reproduced to/from a groove track, the focus loop gain is raised from that before the identification. By having the gain lowered in advance, immediately after the insertion of an LTH disc which has a higher degree of groove modulation into the apparatus, it is possible to reduce the generation of a focus driving current due to an optical crosstalk component and the fluctuation of the focus control due to optical crosstalk, and it is therefore possible to reduce the power consumption and improve the stability of the focus control, thereby improving the recording/reproduction performance of the optical disc apparatus.

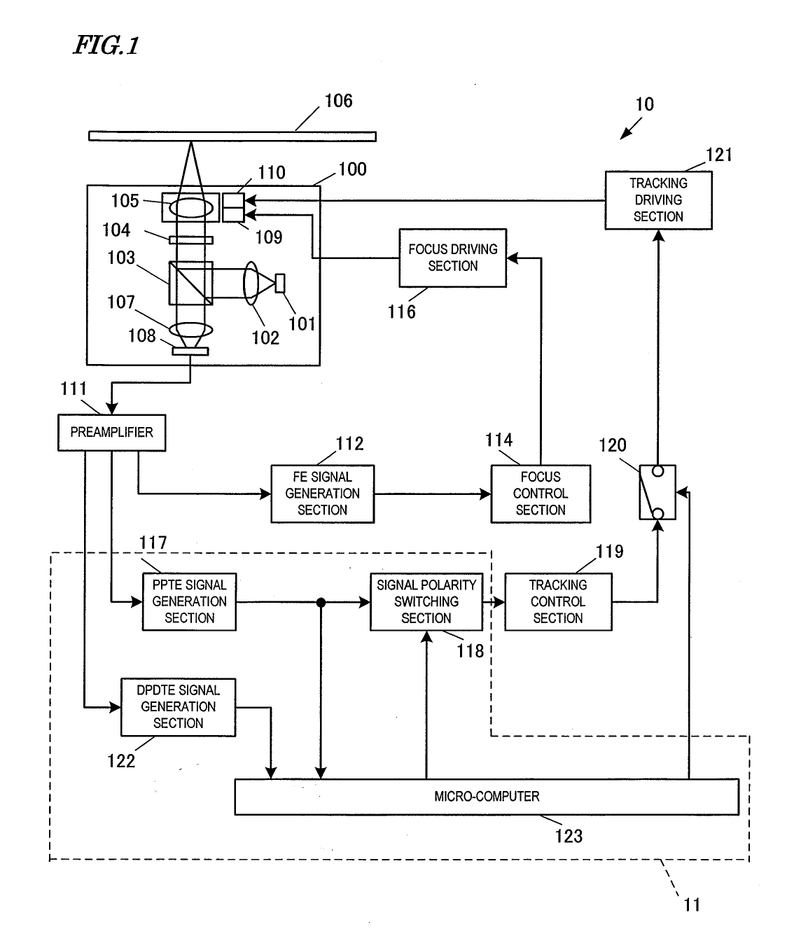

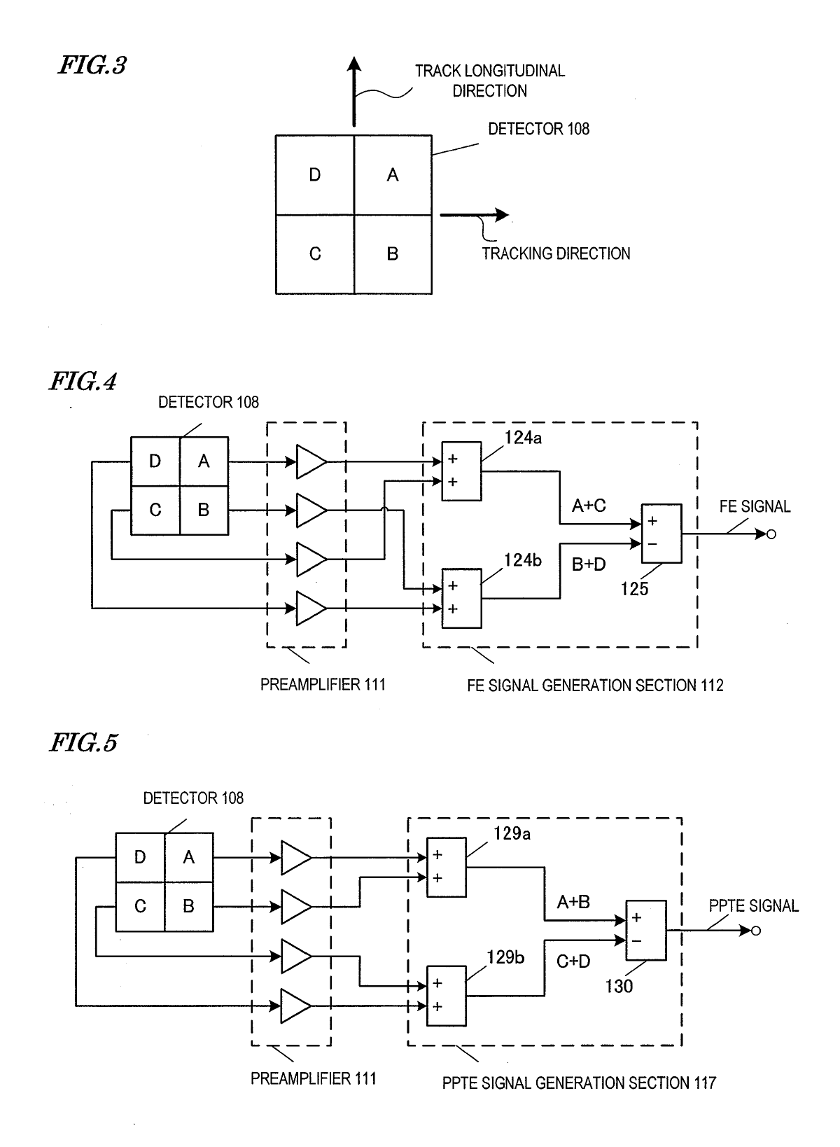

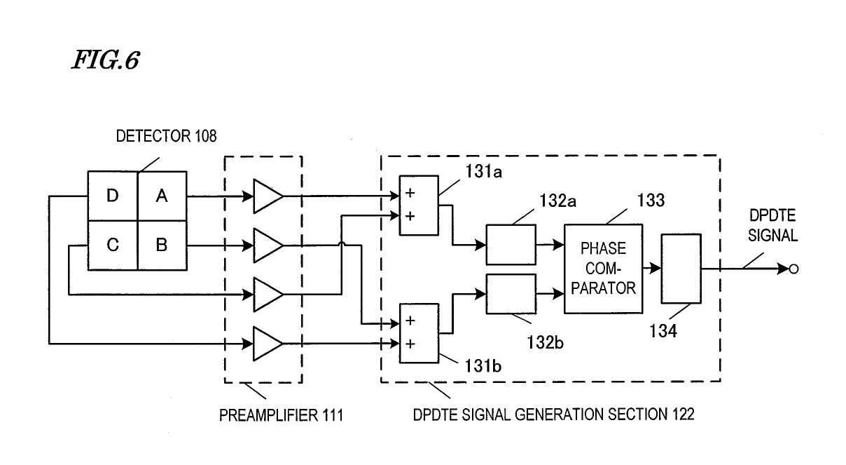

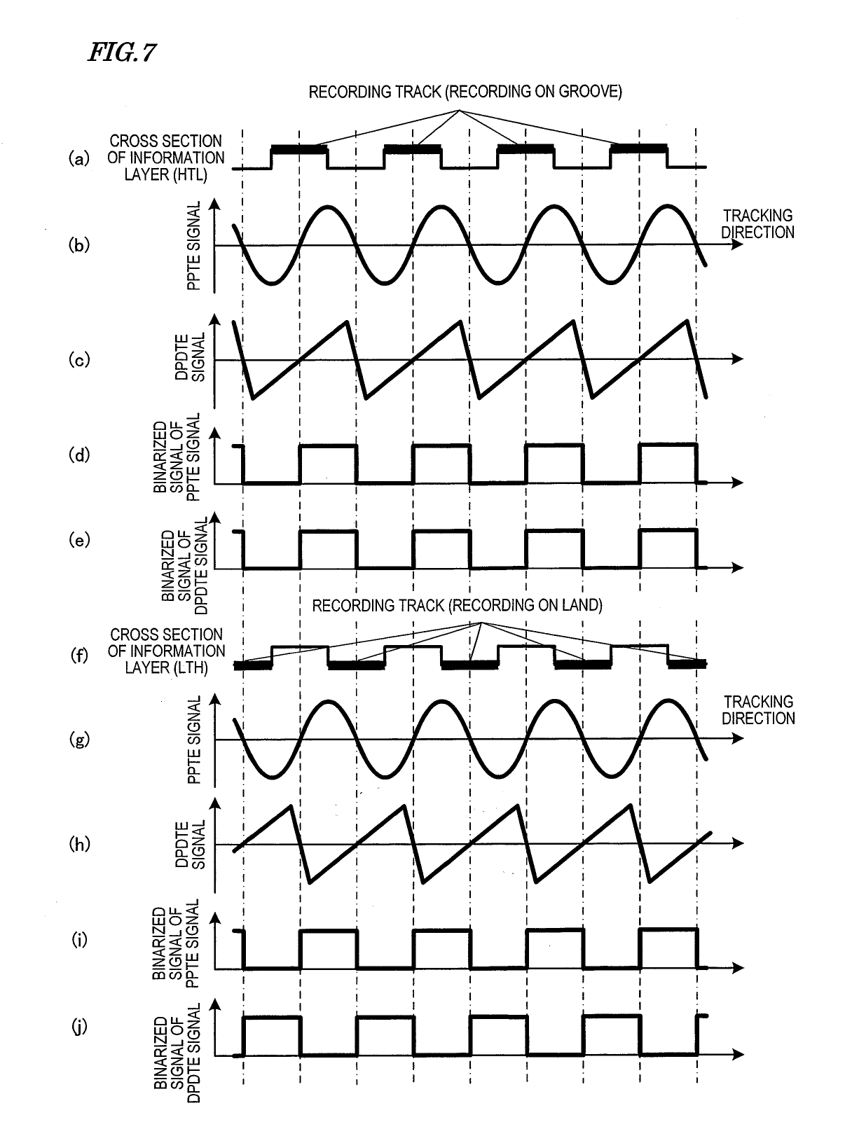

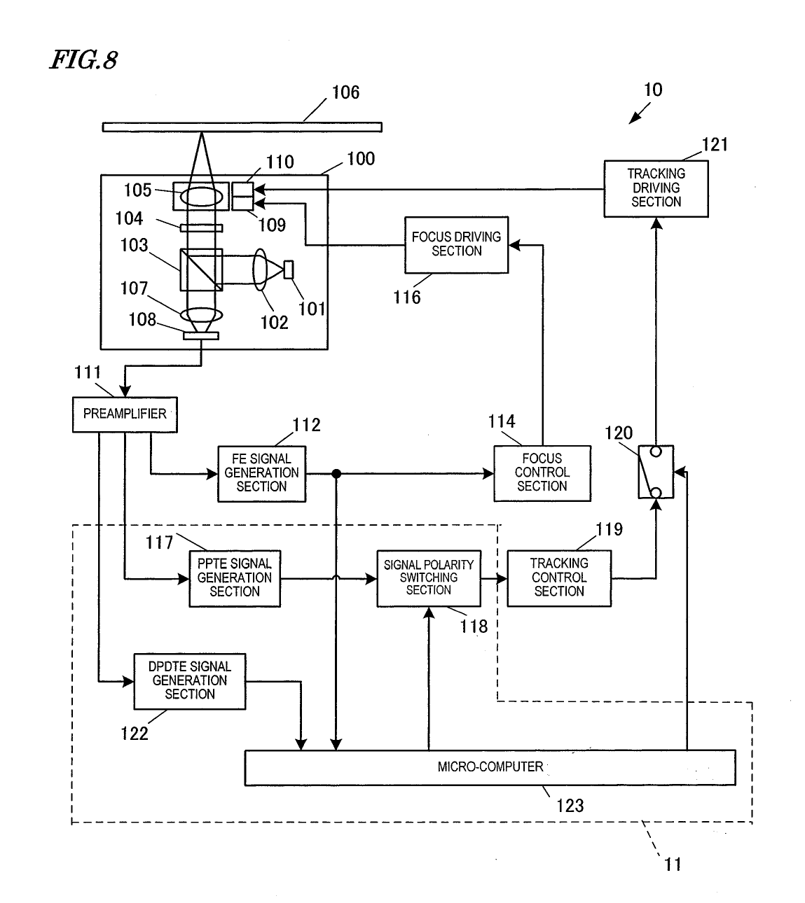

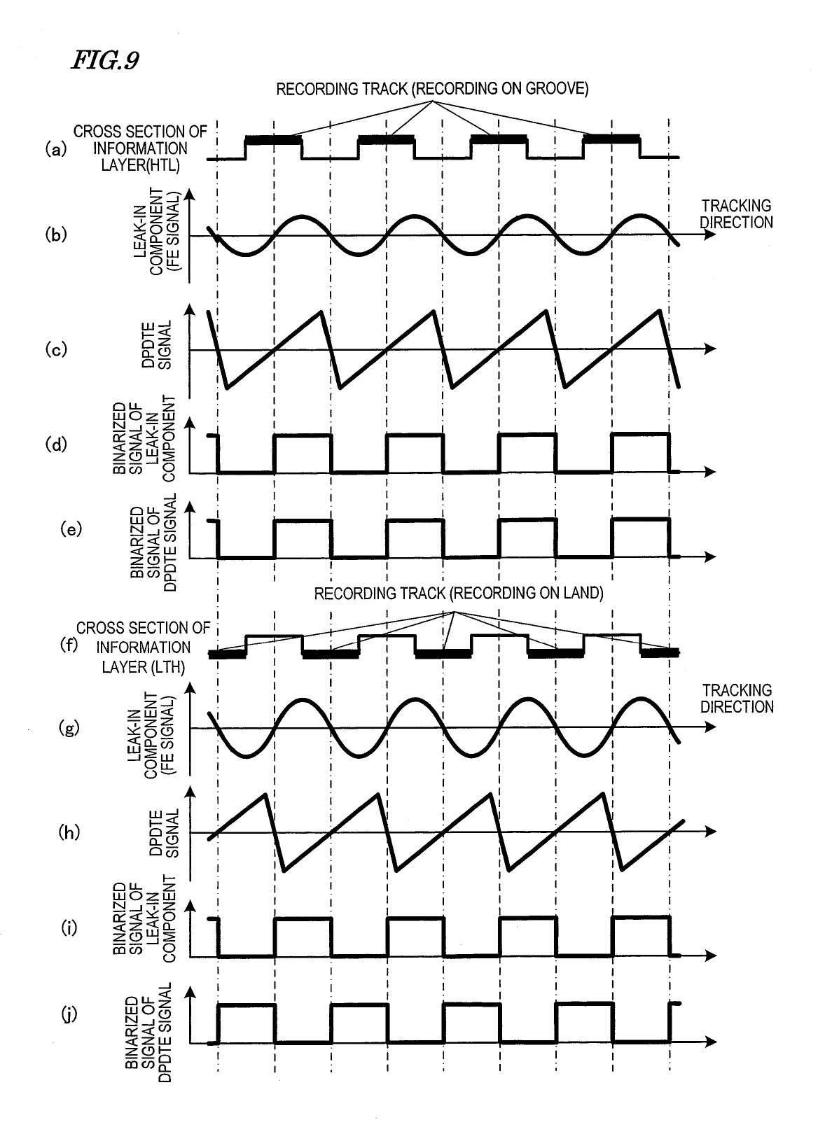

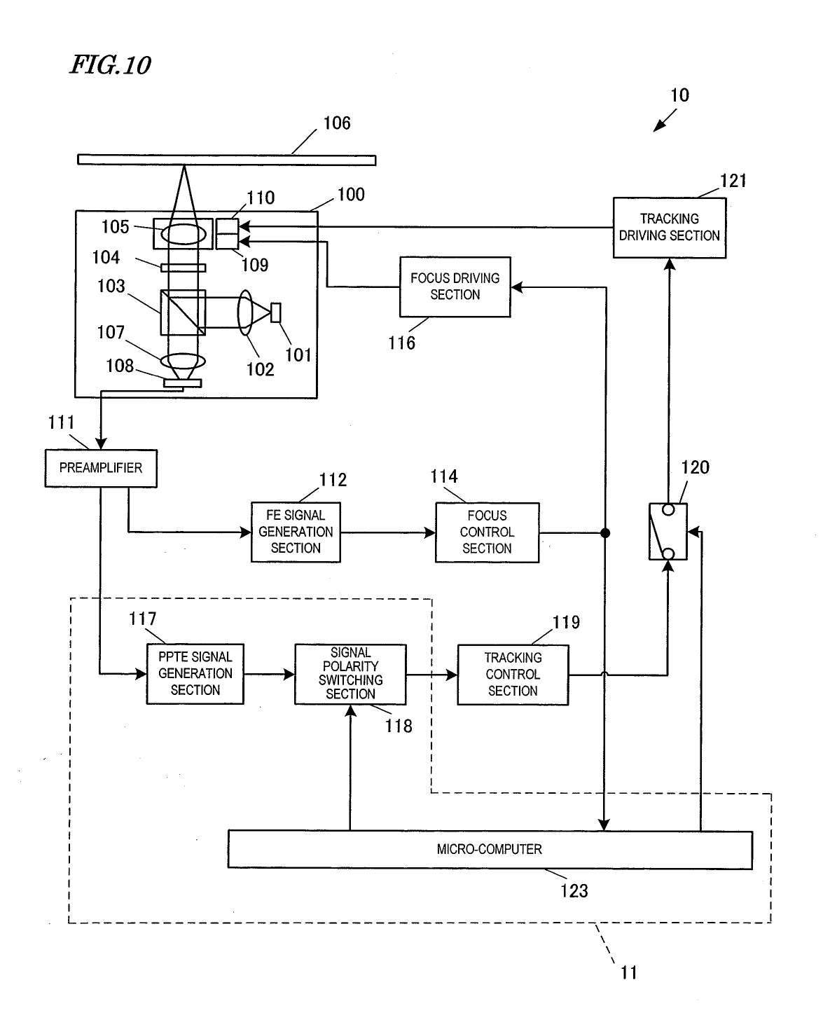

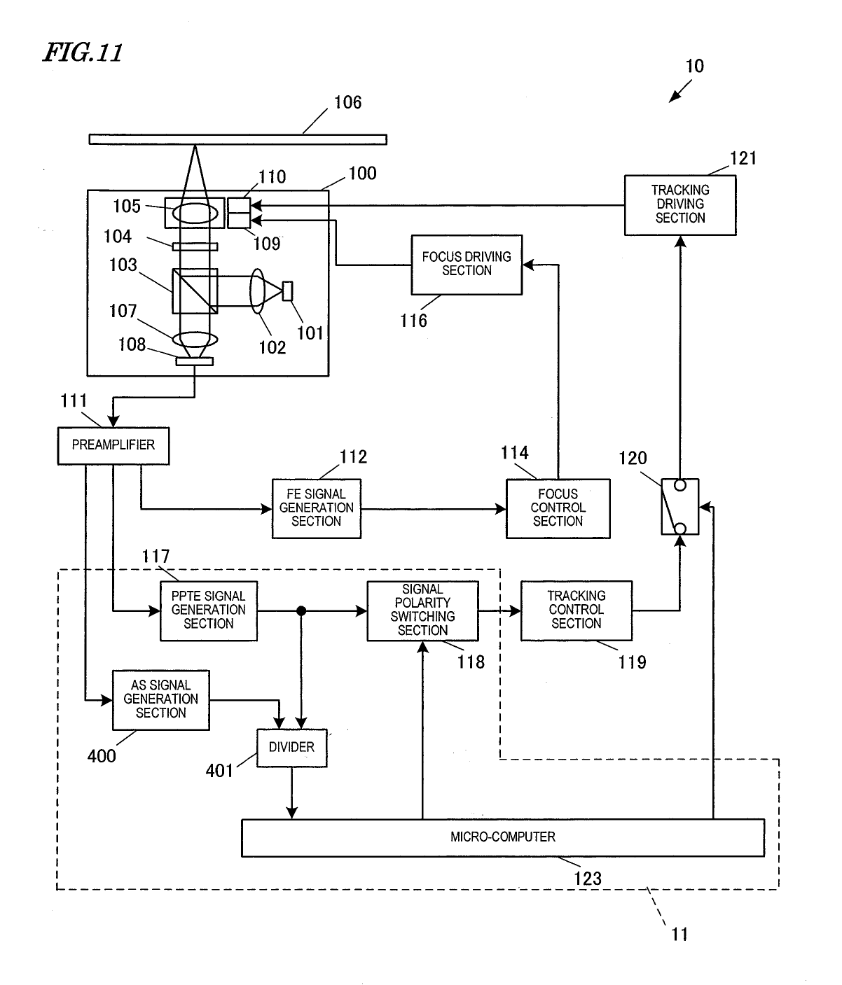

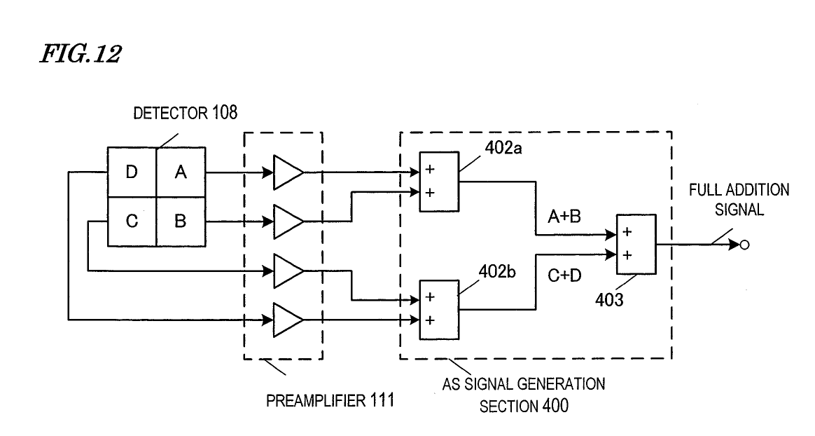

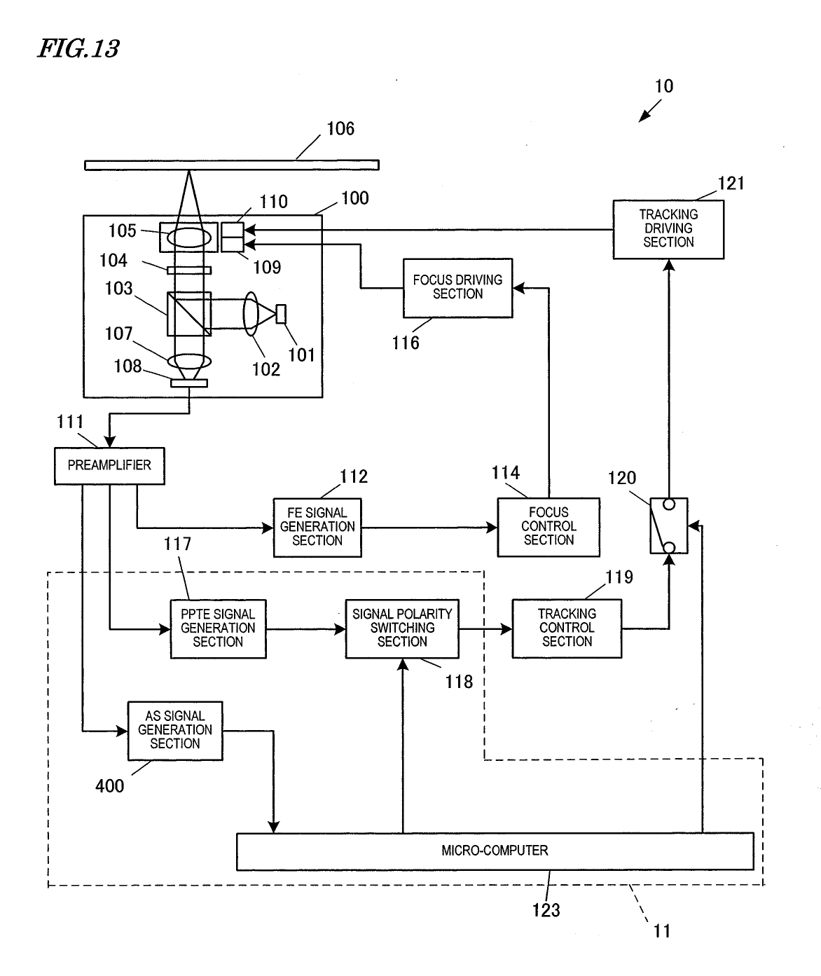

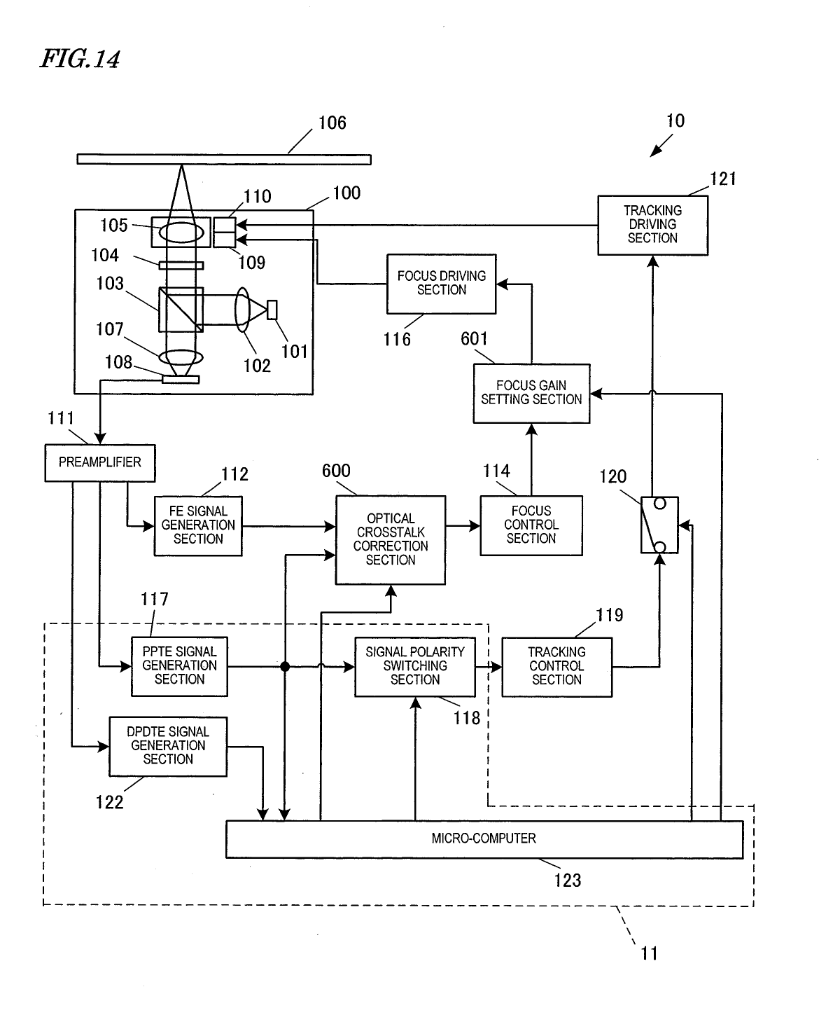

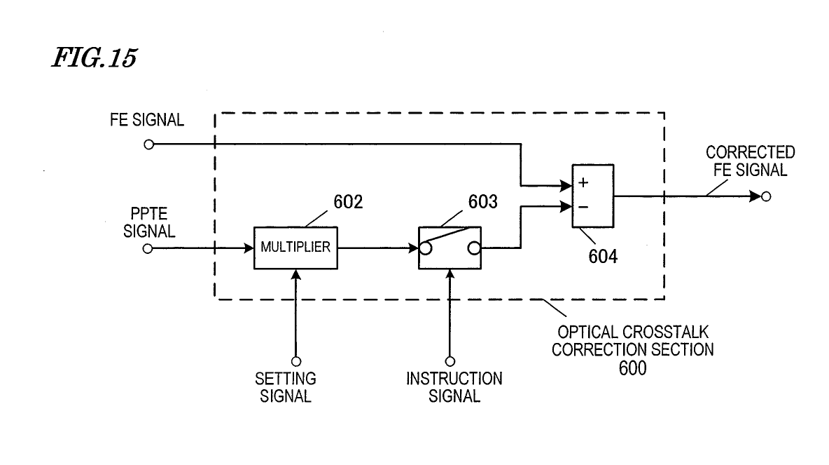

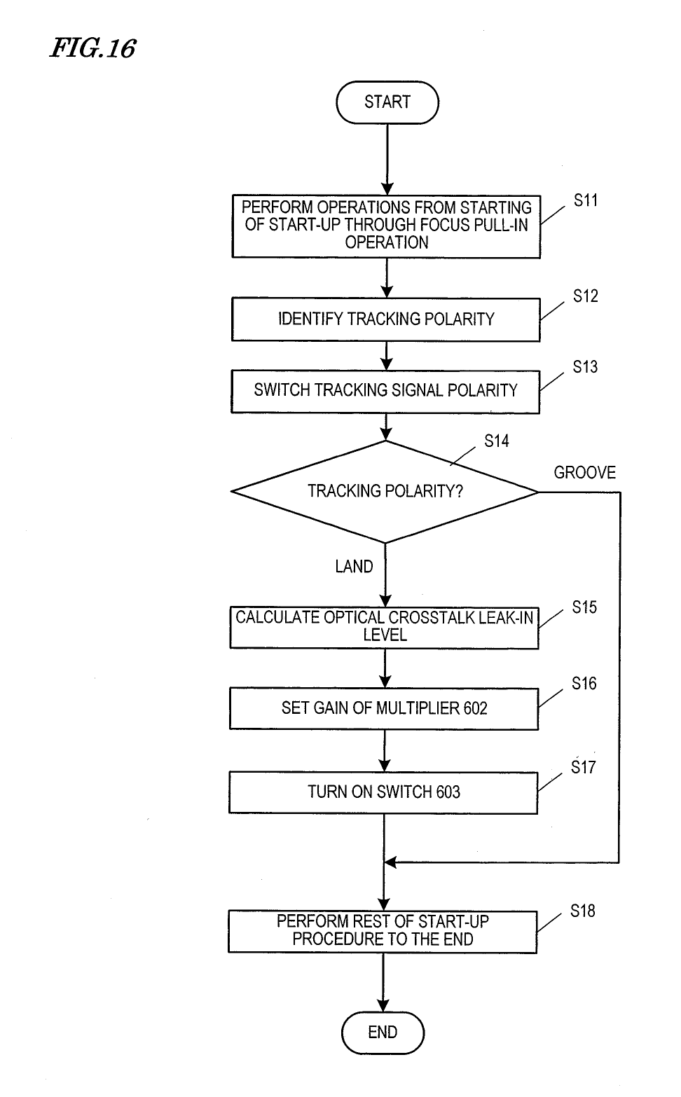

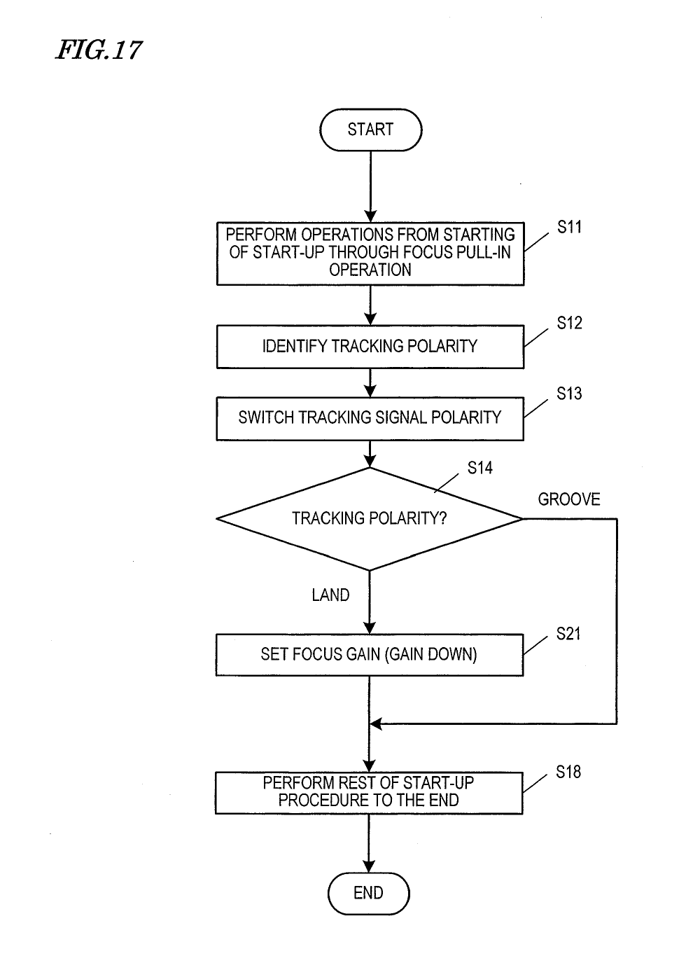

### BRIEF DESCRIPTION OF DRAWINGS

[FIG. 1] A block diagram showing an optical disc apparatus according to Embodiment 1 of the present invention.

[FIGS. 2](a) and (b) are schematic diagrams each showing an optical disc having a groove track and a land track.

[FIG. 3] A plan view showing a detection area of a detector according to Embodiment 1 of the present invention.

[FIG. 4] A block diagram showing an FE signal generation section according to Embodiment 1 of the present invention.

[FIG. 5] A block diagram showing a PPTE signal generation section according to Embodiment 1 of the present invention.

[FIG. 6] A block diagram showing a DPDTE signal generation section according to Embodiment 1 of the present invention.

[FIG. 7](a) to (j) show the relationship between the cross section of an information layer of an HTL disc and that of an LTH disc, the PPTE signal waveform and the DPDTE signal waveform for these discs when the light beam crosses a track, and the waveforms obtained by binarizing these waveforms based on zero-crossings, according to Embodiment 1 of the present invention.

[FIG. 8] A block diagram showing an optical disc apparatus according to Embodiment 2 of the present invention.

[FIG. 9](a) to (j) show the relationship between the cross section of an information layer of an HTL disc and that of an LTH disc, the waveform of the leak-in component into the FE signal due to optical crosstalk when the light beam crosses a track and the DPDTE signal waveform for these discs, and waveforms obtained by binarizing these waveforms based on zero-crossings, according to Embodiment 2 of the present invention.

[FIG. 10] A block diagram showing an optical disc apparatus according to Embodiment 3 of the present invention.

[FIG. 11] A block diagram showing an optical disc apparatus according to Embodiment 4 of the present invention.

[FIG. 12] A block diagram showing an AS signal generation section according to Embodiment 4 of the present invention.

[FIG. 13] A block diagram showing an optical disc apparatus according to Embodiment 5 of the present invention.

[FIG. 14] A block diagram showing an optical disc apparatus according to Embodiment 6 of the present invention.

[FIG. 15] A block diagram showing an optical crosstalk correction section according to Embodiment 6 of the present invention.

[FIG. 16] A flow chart showing a procedure for a tracking polarity identification and an optical crosstalk correction switching upon the apparatus start-up according to Embodiment 6 of the present invention.

[FIG. 17] A flow chart showing a procedure for a tracking polarity identification and a focus gain setting switching upon the apparatus start-up according to Embodiment 6 of the present invention.

### DESCRIPTION OF EMBODIMENTS

Embodiments of the present invention will now be described with reference to the drawings.

### Embodiment 1

FIG. 1 is a block diagram showing an optical disc apparatus 10 according to Embodiment 1 of the present invention. The optical disc apparatus 10 is, for example, a recording/reproduction apparatus, a reproduction-only apparatus, a recording apparatus, an editing apparatus, etc.

In FIG. 1, a light source 101 is, for example, a semiconductor laser device, and is a light source for outputting a light beam onto the information layer of an information carrier 106. The information carrier 106 is an optical disc where data is recorded on one of the groove track and the land track. The information carrier 106 may be a read-only optical disc. The optical disc apparatus 10 records and/or reproduces data to/from the optical disc 106.

A collimator lens 102 is a lens that converts divergent light emitted from the light source 101 into collimated light. A polarizing beam splitter 103 is an optical element that totally reflects linearly-polarized light emitted from the light source 101 while totally transmitting linearly-polarized light that is perpendicular to the linearly-polarized light emitted from the light source 101. A ¼ wave plate 104 is an optical element that converts the polarization of light passing therethrough from circular polarization to linear polarization or from linear polarization to circular polarization. An object lens 105 is a lens that concentrates a light beam onto the information layer of the optical disc 106.

The optical disc 106 is an optical disc that has the groove track and the land track, as shown in FIGS. 2(a) and 2(b), and records data on either the groove track or the land track.

A condenser lens 107 is a lens that concentrates a light beam having passed through the polarizing beam splitter 103 onto a detector 108. The detector 108 is an element that converts received light into an electrical signal, and has a detection area divided in four areas.

FIG. 3 is a plan view showing the detection area of the detector 108. As shown in FIG. 3, the detection area of the detector 108 is divided into four areas A, B, C and D. The left-right direction of the figure corresponds to the radial direction (hereinafter referred to as the “tracking direction”) of the optical disc 106, and the up-down direction corresponds to the track longitudinal direction.

A preamplifier 111 is an electrical element that converts the output current from each area of the detector 108 into a voltage. An FE signal generation section 112 is an electrical circuit that generates, from a plurality of output signals from the preamplifier 111, a focus error signal (hereinafter referred to as an “FE signal”) corresponding to the state of convergence of the light beam on the information layer of the optical disc 106 by the astigmatism method.

FIG. 4 shows a configuration of the FE signal generation section 112. As shown in FIG. 4, an adder 124a is an electrical circuit that adds together two output signals, which are obtained by converting the output currents from the detection areas A and C of the detector 108 into voltages by means of the preamplifier 111, to output the result. An adder 124b is an electrical circuit that adds together two output signals, which are obtained by converting the output currents from the detection areas B and D of the detector 108 into voltages by means of the preamplifier 111, to output the result. A subtractor 125 is an electrical circuit that performs a subtraction between the signals output from the adders 124a and 124b to output the result.

A focus control section 114 is an electrical circuit that outputs a focus control signal based on the signal output from the FE signal generation section 112. A focus driving section 116 is an electrical circuit that outputs a focus actuator driving signal based on the signal output from the focus control section 114. A focus actuator 109 is an element that moves the object lens 105 in the focus direction, and is driven by the focus actuator driving signal.

A PPTE signal generation section 117 is an electrical circuit that generates, from a plurality of output signals from the preamplifier 111, a push-pull tracking error signal (hereinafter referred to as a “PPTE signal”) representing the positional relationship between the light spot and the track on the information layer of the optical disc 106.

FIG. 5 shows a configuration of the PPTE signal generation section 117. As shown in FIG. 5, an adder 129a is an electrical circuit that adds together two output signals, which are obtained by converting the output currents from the detection areas A and B of the detector 108 into voltages by means of the preamplifier 111, to output the result. An adder 129b is an electrical circuit that adds together two output signals, which are obtained by converting the output currents from the detection areas C and D of the detector 108 into voltages by means of the preamplifier 111, to output the result. A subtractor 130 is an electrical circuit that performs a subtraction between the signals output from the adders 129a and 129b to output the result.

A signal polarity switching section 118 is an electrical circuit that outputs the PPTE signal output from the PPTE signal generation section 117 while switching the polarity thereof from one to another according to the setting signal from a micro-computer 123 (hereinafter referred to as a “microcomputer”). A tracking control section 119 is an electrical circuit that outputs a tracking control signal based on the signal output from the signal polarity switching section 118. A switch 120 is an electrical circuit that turns the tracking control ON and OFF based on the instruction signal from the microcomputer 123. A tracking driving section 121 is an electrical circuit that outputs a tracking actuator driving signal based on the signal output from the switch 120. A tracking actuator 110 is an element that moves the object lens 105 in the tracking direction, and is driven by the tracking actuator driving signal.

A DPDTE signal generation section 122 is an electrical circuit that generates, from a plurality of output signals from the preamplifier 111, a phase difference TE signal (hereinafter referred to as a “DPDTE signal”) representing the positional relationship between the light spot on the information layer of the optical disc 106 and a mark or pit on the track.

FIG. 6 shows a configuration of the DPDTE signal generation section 122. As shown in FIG. 6, an adder 131a is an electrical circuit that adds together two output signals, which are obtained by converting the output currents from the detection areas A and C of the detector 108 into voltages by means of the preamplifier 111, to output the result. An adder 131b is an electrical circuit that adds together two output signals, which are obtained by converting the output currents from the detection areas B and D of the detector 108 into voltages by means of the preamplifier 111, to output the result. Comparators 132a and 132b are electrical circuits that binarize the outputs from the adders 131a and 131b to output the results. A phase comparator 133 is an electrical circuit that makes a comparison between the binarized signals output from the comparators 132a and 132b to output a pulse of a time width corresponding to the phase lead and the phase lag of the edge. A lowpass filter 134 is an electrical circuit that smoothes the pulse signal output from the phase comparator 133.

An optical head 100 of the optical disc apparatus 10 includes the light source 101, the collimator lens 102, the polarizing beam splitter 103, the 1/4 wave plate 104, the object lens 105, the condenser lens 107, the detector 108, the focus actuator 109, and the tracking actuator 110.

As described above, the detector 108 functions as a light-receiving section that receives reflected light from the information layer of the optical disc 106. Note that the detector 108 and the preamplifier 111 may be referred to collectively as a light-receiving section.

The FE signal generation section 112 functions as a focus state detection section that generates the focus error signal representing the state of convergence of the light beam based on the output signal from the detector 108. Note that the preamplifier 111 and the FE signal generation section 112 may be referred to collectively as a focus state detection section.

The focus actuator 109 functions as a focus direction moving section that moves the point of convergence of the light beam in a direction perpendicular to the information layer of the optical disc 106.

The focus control section 114 outputs a signal for the focus control based on the focus error signal. Note that the focus control section 114 and the focus driving section 116 may be referred to collectively as a focus control section, which drives the focus actuator 109 to perform a control such that the point of convergence of the light beam is in a predetermined state of convergence.

The PPTE signal generation section 117 functions as a track shift detection section that detects the positional shift between the position at which the optical disc 106 is irradiated with the light beam and the track. Note that the preamplifier 111 and the PPTE signal generation section 117 may be referred to collectively as a track shift detection section.

The tracking actuator 110 functions as a track direction moving section that moves the point of convergence of the light beam on the optical disc 106 in a direction perpendicular to the track longitudinal direction.

The signal polarity switching section 118, the tracking control section 119, the switch 120 and the tracking driving section 121 drive the tracking actuator 110 based on the signal from the PPTE signal generation section 117 to perform a control such that the point of convergence of the light beam scans properly along the groove track or the land track. The signal polarity switching section 118, the tracking control section 119, the switch 120 and the tracking driving section 121 may be referred to collectively as a tracking control section.

The DPDTE signal generation section 122 functions as a phase difference track shift detection section that detects the positional shift between the mark or pit on the groove track or the land track and the point of convergence of the light beam based on the phase shift of the signal obtained by receiving light. Note that the preamplifier 111 and the DPDTE signal generation section 122 may be referred to collectively as a phase difference track shift detection section. The PPTE signal generation section 117 and the DPDTE signal generation section 122 (and the preamplifier 111) may be referred to collectively as a track shift detection section.

The microcomputer 123 functions as a tracking polarity identification section that identifies whether a tracking control is performed on the groove track or the land track. That is, the microcomputer 123 identifies the type of the optical disc 106 placed in the optical disc apparatus 10, i.e., whether it is an optical disc where data is recorded or reproduced to/from the groove track or an optical disc where data is recorded or reproduced to/from the land track. This identification is made while in a state where a focus control is being performed and a tracking control is not being performed, based on a signal that occurs as the light beam crosses a track. The details of such a signal that occurs as the light beam crosses a track will be described later. Note that the microcomputer 123, the PPTE signal generation section 117 and the DPDTE signal generation section 122 may be referred to collectively as a tracking polarity identification section.

The signal polarity switching section 118 functions as a tracking polarity switching section that switches the tracking polarity from one to another based on the identification result of the type of the optical disc 106. Note that the microcomputer 123 and the signal polarity switching section 118 may be referred to collectively as a tracking polarity switching section.

The PPTE signal generation section 117, the DPDTE signal generation section 122, the microcomputer 123 and the signal polarity switching section 118 may be implemented together in a single semiconductor chip as an integrated circuit 11. Such an integrated circuit 11, when provided in the optical disc apparatus 10, functions as a device for identifying the type of the optical disc 106. Note that not all of those elements need to be implemented in the integrated circuit 11, and other elements may further be implemented in the integrated circuit 11.

Next, the operation of the optical disc apparatus 10 will be described in greater detail.

A light beam of linearly-polarized light emitted from the light source 101 is incident on the collimator lens 102, and is turned into collimated light by the collimator lens 102. The light beam having been turned into collimated light by the collimator lens 102 is incident on the polarizing beam splitter 103. The light beam reflected off the polarizing beam splitter 103 is turned into circularly-polarized light by the ¼ wave plate 104. The light beam having been turned into circularly-polarized light by the ¼ wave plate 104 is incident on the object lens 105, and is converged onto the optical disc 106.

The light beam reflected off the optical disc 106 passes through the polarizing beam splitter 103 to be incident on the condenser lens 107. The light beam having been incident on the condenser lens 107 is incident on the detector 108. The light beam having been incident on the detector 108 is converted into an electrical signal in each of the areas A to D. The electrical signals obtained in different areas of the detector 108 are each converted into a voltage by the preamplifier 111. The plurality of output signals from the preamplifier 111 are subjected to an operation by the astigmatism method through the FE signal generation section 112 to yield an FE signal. The FE signal output from the FE signal generation section 112 is input to the focus control section 114, and is turned into a focus driving signal through a phase compensation circuit and a low-frequency compensation circuit, each of which is a digital filter being a DSP (digital signal processor), for example. The focus driving signal output from the focus control section 114 is input to the focus driving section 116, where it is amplified and output to the focus actuator 109.

Through the above operation, there is realized a focus control such that the state of convergence of the light beam on the information layer of the optical disc 106 is always in a predetermined state of convergence by using the FE signal.

The plurality of output signals from the preamplifier 111 are subjected to an operation by the push-pull method through the PPTE signal generation section 117 to yield a PPTE signal. The plurality of output signals from the preamplifier 111 are also subjected to an operation by the differential phase ditection method through the DPDTE signal generation section 122 to yield a DPDTE signal. The PPTE signal output from the PPTE signal generation section 117 and the DPDTE signal output from the DPDTE signal generation section 122 are input to the microcomputer 123.

The microcomputer 123 identifies whether data is recorded on the groove track or the land track on the information layer of the optical disc 106 being irradiated with the light beam, based on the PPTE signal and the DPDTE signal received, to thereby determine the tracking polarity with which a tracking control should be performed, and outputs a control signal to the signal polarity switching section 118.

The PPTE signal from the PPTE signal generation section 117 is input to the signal polarity switching section 118. The signal polarity switching section 118 outputs, to the tracking control section 119, a signal obtained by switching the polarity of the received PPTE signal based on the control signal received from the microcomputer 123.

The signal input to the tracking control section 119 is turned into a tracking driving signal through a phase compensation circuit and a low-frequency compensation circuit, each of which is a digital filter being a DSP, for example. The tracking driving signal from the tracking control section 119 is input to the switch 120. The switch 120 turns ON the switch based on the instruction signal from the microcomputer 123 according to the tracking pull-in operation, and outputs the tracking driving signal to the tracking driving section 121. The tracking driving signal input to the tracking driving section 121 is amplified and output to the tracking actuator 110.

Through the above operation, there is realized a tracking control such that an intended track, which is the groove track or the land track on which data is recorded on the information layer of the optical disc 106, is scanned properly by using the PPTE signal.

Note that the state where a tracking control is performed refers to a state where the tracking actuator 110 is moving the object lens 105 along the tracking direction according to the driving signal. The state where a tracking control is not being performed refers to a state where the tracking actuator 110 is not moving the object lens 105 along the tracking direction according to the driving signal. While the state where a tracking control is not being performed can be achieved by turning OFF the switch 120, for example, it may be achieved by another operation.

Now, the tracking polarity identification (disc type identification) of the present embodiment will be described with reference to FIG. 7.

FIG. 7 shows the correspondence between the cross section of the information layer of a groove track recording disc (an HTL disc) and that of a land track recording disc (an LTH disc), the PPTE signal waveform and the DPDTE signal waveform for these discs, and waveforms of signals obtained by binarizing these TE signals based on zero-crossings.

FIG. 7(a) is a cross-sectional view of the information layer of an HTL disc, and FIG. 7(f) is a cross-sectional view of the information layer of an LTH disc, wherein each disc is irradiated with a light beam coming from the upper side of the figure.

The center of a groove track is denoted by a broken line, and the center of a land track is denoted by a one-dot chain line. Marks are formed on the groove track for an HTL disc, and on the land track for an LTH disc.

FIGS. 7(b) and 7(g) show PPTE signals detected when the light beam crosses a track for the information layers of the discs of FIGS. 7(a) and 7(f), respectively.

As shown in FIGS. 7(b) and 7(g), the PPTE signal detected when the light beam crosses a track has a sinusoidal waveform that crosses zero at each of groove tracks and land tracks. The signal shape of the PPTE signal detected when the light beam crosses a track is the same between an HTL disc and an LTH disc even though the amplitude may differ.

On the other hand, FIGS. 7(c) and 7(h) show DPDTE signals detected when the light beam crosses a track for the information layers of the discs of FIGS. 7(a) and 7(f), respectively.

Herein, the differential phase ditection method for generating the DPDTE signal is a method of detecting the positional shift in the tracking direction between a pit or mark and the light beam when the light beam passes through the pit or mark, and is therefore not dependent on the track polarity. Thus, a DPDTE signal has a sawtoothed waveform that crosses zero at a track where a mark exists, as shown in FIGS. 7(c) and 7(h).

FIGS. 7(d) and 7(e) show signals obtained by binarizing the signals of FIGS. 7(b) and 7(c), respectively, based on zero-crossings. FIGS. 7(i) and 7(j) show signals obtained by binarizing the signals of FIGS. 7(g) and 7(h), respectively, based on zero-crossings.

In the present embodiment, the tracking polarity is identified by utilizing the characteristics of the PPTE signal and the DPDTE signal described above.

That is, focusing on the phase relationship between the PPTE signal and the DPDTE signal when the light beam crosses a track, a disc is identified as a groove track recording disc if the PPTE signal and the DPDTE signal are in phase with each other as shown in FIGS. 7(b) and 7(c), and a disc is identified as a land track recording disc if the PPTE signal and the DPDTE signal are in antiphase with each other as shown in FIGS. 7(g) and 7(h).

The phase relationship between the PPTE signal and the DPDTE signal is identified based on signals obtained by binarizing these signals based on zero-crossings.

That is, it is determined that the PPTE signal and the DPDTE signal are in phase with each other if the signal obtained by binarizing the DPDTE signal is high in a period in which the signal obtained by binarizing the PPTE signal is high, as shown in FIGS. 7(d) and 7(e).

On the other hand, it is determined that the PPTE signal and the DPDTE signal are in antiphase with each other if the signal obtained by binarizing the DPDTE signal is low in a period in which the signal obtained by binarizing the PPTE signal is high, as shown in FIGS. 7(i) and 7(j).

As described above, the tracking polarity can be identified based on the PPTE signal and the DPDTE signal when the light beam crosses a track.

Therefore, since the tracking polarity can be identified without performing a tracking pull-in operation, it is possible to shorten the tracking polarity identification time and to thereby shorten the start-up time.

Note that while the phase relationship between the PPTE signal and the DPDTE signal is identified in the tracking polarity identification using signals obtained by binarizing these signals based on zero-crossings in the present embodiment, the present invention is not limited to identification methods using such signals.

### Embodiment 2

FIG. 8 is a block diagram showing the optical disc apparatus 10 of Embodiment 2. Note that like elements to those of the optical disc apparatus 10 shown in FIG. 1 will be denoted by like reference numerals and will not be described repeatedly below.

In the present embodiment, the microcomputer 123 functions as a tracking polarity identification section that identifies the tracking polarity based on the phase relationship between a component of the focus error signal and the differential phase ditection tracking error signal. Note that the microcomputer 123, the FE signal generation section 112 and the DPDTE signal generation section 122 may be referred to collectively as a tracking polarity identification section.

Next, the operation of the optical disc apparatus 10 of the present embodiment will be described. Note that similar operations to those of Embodiment 1 will not be described below.

The FE signal from the FE signal generation section 112 and the DPDTE signal from the DPDTE signal generation section 122 are input to the microcomputer 123. The microcomputer 123 identifies whether data is recorded on the groove track or the land track on the information layer of the optical disc 106 being irradiated with the light beam, based on the FE signal and the DPDTE signal received, to thereby determine the tracking polarity with which a tracking control should be performed, and outputs a control signal to the signal polarity switching section 118.

Now, the tracking polarity identification of the present embodiment will be described with reference to FIG. 9. Note that similar portions to those of FIG. 7 will not be described below.

FIG. 9 shows the correspondence between the cross section of the information layer of a groove track recording disc (an HTL disc) and that of a land track recording disc (an LTH disc), the waveform of an optical crosstalk leak-in component mixing into the FE signal and the DPDTE signal waveform for these discs, and waveforms of signals obtained by binarizing the leak-in component and the DPDTE signal based on zero-crossings.

FIGS. 9(a) and 9(f) each show the cross section of the information layer, as do FIGS. 7(a) and 7(f). FIGS. 9(b) and 9(g) show optical crosstalk leak-in components of FE signals detected when the light beam crosses a track for the information layers of the discs of FIGS. 9(a) and 9(f), respectively. Since an optical crosstalk is a phenomenon of the PPTE signal leaking into the FE signal, as described above, the leak-in component is a signal in phase with the PPTE signal.

Therefore, for each disc, the optical crosstalk leak-in component of the FE signal (FIGS. 9(b) and 9(g)) when the light beam crosses a track is a signal in phase with the PPTE signal (FIGS. 7(b) and 7(g)) when the light beam crosses a track.

FIGS. 9(d) and 9(e) show signals obtained by binarizing the signals of FIGS. 9(b) and 9(c), respectively, based on zero-crossings. FIGS. 9(i) and 9(j) show signals obtained by binarizing the signals of FIGS. 9(g) and 9(h), respectively, based on zero-crossings.

In the present embodiment, the tracking polarity is identified by utilizing the characteristics of the optical crosstalk leak-in component and the DPDTE signal. That is, the tracking polarity is identified as in Embodiment 1, focusing on the fact that the optical crosstalk leak-in component in the FE signal when the light beam crosses a track is in phase with the PPTE signal.

That is, a disc is identified as a groove track recording disc if the optical crosstalk leak-in component and the DPDTE signal are in phase with each other as shown in FIGS. 9(b) and 9(c). A disc is identified as a land track recording disc if the optical crosstalk leak-in component and the DPDTE signal are in antiphase with each other as shown in FIGS. 9 (g) and 9(h).

The phase relationship between the optical crosstalk leak-in component and the DPDTE signal is identified based on signals obtained by binarizing these signals based on zero-crossings, as in Embodiment 1.

That is, it is determined that the optical crosstalk leak-in component and the DPDTE signal are in phase with each other if the signal obtained by binarizing the DPDTE signal is high in a period in which the signal obtained by binarizing the optical crosstalk leak-in component is high, as shown in FIGS. 9(d) and 9(e).

On the other hand, it is determined that the optical crosstalk leak-in component and the DPDTE signal are in antiphase with each other if the signal obtained by binarizing the DPDTE signal is low in a period in which the signal obtained by binarizing the optical crosstalk leak-in component is high, as shown in FIGS. 9(i) and 9(j).

As described above, the tracking polarity can be identified by using the optical crosstalk leak-in component in the FE signal and the DPDTE signal when the light beam crosses a track.

Therefore, since the tracking polarity can be identified without performing a tracking pull-in operation, it is possible to shorten the identification time and to thereby shorten the start-up time.

Note that while the phase relationship between the optical crosstalk leak-in component of the FE signal and the DPDTE signal is identified using signals obtained by binarizing these signals based on zero-crossings in the present embodiment, the present invention is not limited to identification methods using such signals.

### Embodiment 3

FIG. 10 is a block diagram showing the optical disc apparatus 10 of Embodiment 3. Note that like elements to those of the optical disc apparatus 10 shown in FIG. 1 will be denoted by like reference numerals and will not be described repeatedly below.

In the present embodiment, the microcomputer 123 functions as a tracking polarity identification section that identifies the tracking polarity based on the magnitude of the amplitude of the output signal from the focus control section 114. Note that the microcomputer 123 and the focus control section 114 may be referred to collectively as a tracking polarity identification section.

Next, the operation of the optical disc apparatus 10 of the present embodiment will be described. Note that similar operations to those of Embodiment 1 will not be described below.

The focus driving signal output from the focus control section 114 is input to the microcomputer 123. The microcomputer 123 identifies whether data is recorded on the groove track or the land track on the information layer of the optical disc 106 being irradiated with the light beam, based on the amplitude of the focus driving signal received, to thereby determine the tracking polarity with which a tracking control should be performed, and outputs a control signal to the signal polarity switching section 118.

Now, the tracking polarity identification of the present embodiment will be described.

When a focus control is performed using an FE signal containing an optical crosstalk, one can observe a signal amplitude according to the optical crosstalk component in the focus driving signal output from the focus control section 114. As described above, because of the relationship between the laser light wavelength and the groove depth, an LTH disc where data is recorded on the land track has a higher degree of groove modulation than an HTL disc. Therefore, as compared with an HTL disc, it has a larger amount of the optical crosstalk component occurring as the PPTE signal leaks into the FE signal when the light beam crosses a track. When a focus control is performed with an FE signal containing an optical crosstalk component, one can observe a signal amplitude according to the optical crosstalk component in the focus driving signal which is the output from the focus control section 114. That is, one can observe different signal amplitudes between an LTH disc and an HTL disc in the focus driving signal when the light beam crosses a track while in a state where a focus control is being performed. Herein, the amplitude of the focus driving signal can be detected as a value obtained by integrating the absolute value of the focus driving signal over a predetermined period of time.

Therefore, a disc can be identified as an LTH disc having a higher degree of groove modulation if the integrated value is greater than a predetermined threshold value.

Since an LTH disc is a disc with which a tracking control is performed on the land track, as described above, the type (tracking polarity) of a disc can be identified based on the focus driving signal amplitude.

As described above, the tracking polarity can be identified from the focus driving signal amplitude when the light beam crosses a track.

Therefore, since the tracking polarity can be identified without performing a tracking pull-in operation, it is possible to shorten the identification time and to thereby shorten the start-up time.

Note that while the tracking polarity is identified using the focus driving signal output from the focus control section 114 in the present embodiment, the identification can be made similarly by measuring the current flowing through the focus actuator 109.

### Embodiment 4

FIG. 11 is a block diagram showing the optical disc apparatus 10 of Embodiment 4. Note that like elements to those of the optical disc apparatus 10 shown in FIG. 1 will be denoted by like reference numerals and will not be described repeatedly below.

The optical disc apparatus 10 of the present embodiment includes an AS signal generation section 400 and a divider 401. The AS signal generation section 400 is an electrical circuit that generates, from the output signal from the preamplifier 111, a full addition signal (hereinafter referred to as an “AS signal”) for detecting the amount of return light from the information layer of the optical disc 106.

FIG. 12 shows a configuration of the AS signal generation section 400. As shown in FIG. 12, an adder 402a is an electrical circuit that adds together two output signals, which are obtained by converting the output currents from the detection areas A and B of the detector 108 into voltages by means of the preamplifier 111, to output the result. An adder 402b is an electrical circuit that adds together two output signals, which are obtained by converting the output currents from the detection areas C and D of the detector 108 into voltages by means of the preamplifier 111, to output the result. An adder 403 is an electrical circuit that adds together signals output from the adders 402a and 402b, to output the result.

The divider 401 is an electrical circuit that divides the PPTE signal output from the PPTE signal generation section 117 by the AS signal output from the AS signal generation section 400, to output the result.

In the present embodiment, the AS signal generation section 400 functions as a reflected light amount detection section that detects the amount of return light of the light beam. Note that the AS signal generation section 400 and the preamplifier 111 may be referred to collectively as a reflected light amount detection section.

The divider 401 functions as a TE signal normalization section that normalizes the PPTE signal with the AS signal.

In the present embodiment, the microcomputer 123 functions as a tracking polarity identification section that identifies the tracking polarity based on the magnitude of the amplitude of the normalized PPTE signal. Note that the microcomputer 123, the AS signal generation section 400 and the divider 401 may be referred to collectively as a tracking polarity identification section.

Next, the operation of the optical disc apparatus 10 of the present embodiment will be described. Note that similar operations to those of Embodiment 1 will not be described below.

The output signals from the preamplifier 111 are subjected to an operation through the AS signal generation section 400 to yield an AS signal. The PPTE signal from the PPTE signal generation section 117 and the AS signal from the AS signal generation section 400 are input to the divider 401, and a normalized PPTE signal is output as the result of dividing the PPTE signal by the AS signal. The normalized PPTE signal from the divider 401 is input to the microcomputer 123.

The microcomputer 123 identifies whether data is recorded on the groove track or the land track of the information layer of the optical disc 106 being irradiated with the light beam, based on the amplitude of the normalized PPTE signal received, to thereby determine the tracking polarity with which a tracking control should be performed, and outputs a control signal to the signal polarity switching section 118.

Now, the tracking polarity identification of the present embodiment will be described.

As described above, an LTH disc where data is recorded on the land track has a higher degree of groove modulation. The degree of groove modulation can be calculated as the amplitude of a signal obtained by dividing the PPTE signal when the light beam crosses a track by the AS signal, and this is the normalized PPTE signal amplitude of the present embodiment. According to optical disc standards, the degree of groove modulation of an HTL disc is 0.21 to 0.45, and the degree of groove modulation of an LTH disc is 0.21 to 0.60.

Based on these standard values, an HTL disc and an LTH disc may possibly have an equal degree of groove modulation, but the degree of modulation of an actual product LTH disc is close to the upper limit standard value, and is 0.5 or more.

Therefore, it is possible to identify whether a disc is an LTH disc which has a higher degree of groove modulation based on whether or not the normalized PPTE signal amplitude is greater than the threshold value 0.5. Since an LTH disc is a disc where a tracking control is performed on the land track, as described above, the type (tracking polarity) of a disc can be identified based on the normalized PPTE signal amplitude.

As described above, the tracking polarity can be identified from the normalized PPTE signal amplitude when the light beam crosses a track.

Therefore, since the tracking polarity can be identified without performing a tracking pull-in operation, it is possible to shorten the identification time and to thereby shorten the start-up time.

Note that while the threshold value for the identification based on the normalized PPTE signal amplitude is set to 0.5 in the present embodiment, the threshold value is merely an example and may be a different value.

### Embodiment 5

FIG. 13 is a block diagram showing a configuration of the optical disc apparatus 10 of Embodiment 5. Note that like elements to those of the optical disc apparatus 10 of Embodiments 1 and 4 will be denoted by like reference numerals and will not be described repeatedly below.

In the present embodiment, the microcomputer 123 functions as a tracking polarity identification section that identifies the tracking polarity based on the level of the AS signal. The level of the AS signal is, for example, the AS signal amplitude. Note that the microcomputer 123 and the AS signal generation section 400 may be referred to collectively as a tracking polarity identification section.

Next, the operation of the optical disc apparatus 10 of the present embodiment will be described. Note that similar operations to those of Embodiments 1 and 4 will not be described below.

The AS signal from the AS signal generation section 400 is input to the microcomputer 123. The microcomputer 123 identifies whether data is recorded on the groove track or the land track of the information layer of the optical disc 106 being irradiated with the light beam, based on the level of the AS signal received, to thereby determine the tracking polarity with which a tracking control should be performed, and outputs a control signal to the signal polarity switching section 118.

Now, the tracking polarity identification of the present embodiment will be described.

As described above, an LTH disc where data is recorded on the land track has an increased reflectance after the recording. According to the disc standards, a recorded HTL disc has a reflectance of 11% to 24%, and a recorded LTH disc has a reflectance of 16% to 35%.

Based on these standard values, an HTL disc and an LTH disc may possibly have an equal reflectance, but the reflectance of an actual product LTH disc is close to the upper limit standard value, and is 30% or more.

Therefore, it is possible to identify whether a disc is an LTH disc which has a higher reflectance based on whether or not the AS signal level is greater than a signal level that corresponds to a reflectance of 30%. Since an LTH disc is a disc where a tracking control is performed on the land track, as described above, the type (tracking polarity) of a disc can be identified based on the AS signal level.

As described above, the tracking polarity can be identified from the AS signal level.

Therefore, since the tracking polarity can be identified without performing a tracking pull-in operation, it is possible to shorten the identification time and to thereby shorten the start-up time.

Note that while the threshold value for the identification based on the AS signal level is set to a signal level that corresponds to a reflectance of 30% in the present embodiment, the threshold value is merely an example and may be a different value.

### Embodiment 6

FIG. 14 is a block diagram showing the optical disc apparatus 10 of Embodiment 6. Note that like elements to those of the optical disc apparatus 10 shown in FIG. 1 will be denoted by like reference numerals and will not be described repeatedly below.

The optical disc apparatus 10 of the present embodiment includes an optical crosstalk correction section 600 and a focus gain setting section 601. The optical crosstalk correction section 600 is an electrical circuit that generates and outputs a corrected FE signal from the output signal from the FE signal generation section 112 and the output signal from the PPTE signal generation section 117.

FIG. 15 shows a configuration of the optical crosstalk correction section 600. As shown in FIG. 15, a multiplier 602 is an electrical circuit that multiplies the PPTE signal output from the PPTE signal generation section 117 by the gain corresponding to the setting signal from the microcomputer 123, to output the result. A switch 603 is an electrical circuit that is turned ON and OFF based on the instruction signal from the microcomputer 123. A subtractor 604 is an electrical circuit that performs a subtraction between the FE signal output from the FE signal generation section 112 and the signal output from the switch 603, to output the result.

The focus gain setting section 601 is an electrical circuit that sets a gain corresponding to the setting signal from the microcomputer 123. The focus driving section 116 outputs the focus actuator driving signal based on the signal output from the focus gain setting section 601. The focus actuator 109 moves the object lens 105 in the focus direction.

The optical crosstalk correction section 600 corrects the optical crosstalk contained in the FE signal. Note that the optical crosstalk correction section 600, the FE signal generation section 112, the PPTE signal generation section 117 and the microcomputer 123 may be referred to collectively as a correction section for correcting such an optical crosstalk contained in an FE signal.

The focus gain setting section 601 sets a focus loop gain for the focus control. Note that the focus gain setting section 601 and the microcomputer 123 may be referred to collectively as a setting section for setting such a focus loop gain for the focus control.

The focus control section 114, the focus gain setting section 601 and the focus driving section 116 may be referred to collectively as a focus control section for outputting a signal for the focus control.

Next, the operation of the optical disc apparatus 10 of the present embodiment will be described. Note that similar operations to those of Embodiment 1 will not be described below.

The FE signal from the FE signal generation section 112 is input to a crosstalk measurement section (not shown), where a comparison is made between the signal amplitude when the tracking control is OFF and the signal amplitude when the tracking control is ON to thereby output the amplitude difference as the leak-in level of an optical crosstalk leaking into the FE signal. Note that the crosstalk measurement section is provided at any position where the FE signal can be received. The detection of the FE signal amplitude when the tracking control is ON is performed after the identification of the type of a disc.

The leak-in level, which is the output from the crosstalk measurement section, is input to the microcomputer 123. The microcomputer 123 outputs a gain setting signal corresponding to the optical crosstalk leak-in level to the optical crosstalk correction section 600 to thereby set the gain of the multiplier 602.

The PPTE signal from the PPTE signal generation section 117 is input to the optical crosstalk correction section 600, and is output after being multiplied by the gain set by the multiplier 602. The output from the multiplier 602 is output to the subtractor 604 via the switch 603. The subtractor 604 performs a subtraction between the FE signal from the FE signal generation section 112 and the output signal from the switch 603, and the result is output as a corrected FE signal, which is a signal obtained by correcting the optical crosstalk leak-in component leaking into the FE signal, and input to the focus control section 114.

The focus control section 114 generates a focus driving signal from the corrected FE signal, and the focus driving signal is input to the focus gain setting section 601. The focus gain setting section 601 multiplies it by a gain corresponding to the setting signal input from the microcomputer 123, to output the result. The signal from the focus gain setting section 601 is input to and amplified through the focus driving section 116, and is output to the focus actuator 109.

Through the above operation, there is realized focus control such that the state of convergence of the light beam on the information layer of the optical disc 106 is always in a predetermined state of convergence, while the optical crosstalk leaking into the FE signal is corrected, by using the corrected FE signal.

Now, the timing with which the tracking polarity identification and the optical crosstalk correction are performed during the start-up procedure of the optical disc apparatus 10 of the present embodiment will be described with reference to FIG. 16.

FIG. 16 is a flow chart showing how the tracking polarity identification and the optical crosstalk correction are performed in the start-up procedure.

First, upon the apparatus start-up, operations from the starting of the start-up through the focus pull-in operation are performed (S11). Then, the microcomputer 123 performs a tracking polarity identification similar to that of Embodiment 1 based on the phase relationship between the PPTE signal and the DPDTE signal received, to thereby identify the tracking polarity of the information layer where the focus control is currently ON (S12). Then, the microcomputer 123 instructs the signal polarity switching section 118 to switch the polarity based on the identification result (S13).

The tracking polarity of the information layer is determined based on the tracking polarity identification result from step S12 (S14). Where it is determined in step S14 that a tracking control is to be performed on the land track, a comparison is made between the FE signal amplitude when the tracking control is OFF and the FE signal amplitude when the tracking control is ON, to thereby calculate the amplitude difference as the leak-in level of the optical crosstalk leaking into the FE signal (S15).

Then, the microcomputer 123 sets the gain of the multiplier 602 based on the optical crosstalk leak-in level (S16). Then, the switch 603 is turned ON according to the instruction signal from the microcomputer 123 (S17), to thereby output the PPTE signal multiplied by the gain of the multiplier 602 to the subtractor 604. The FE signal from the FE signal generation section 112 and the output signal from the switch 603 are subjected to a subtraction through the subtractor 604, to output the result as a corrected FE signal, for which the optical crosstalk leak-in component leaking into the FE signal has been corrected, and the corrected FE signal is used in the focus control. Then, the rest of the start-up procedure is performed to the end (S18), thus completing the start-up.

Where it is determined in step S14 that a tracking control is to be performed on the groove track, the start-up is completed by performing step S18 without performing the optical crosstalk correction.

By such an operation as described above, it is possible to identify the type of a disc and to appropriately switch the polarity while in a state where the focus control is ON and the tracking control is OFF, upon the start-up of the optical disc apparatus 10. Therefore, it is possible to shorten the identification time and to thereby shorten the start-up time of the apparatus.

Moreover, the optical crosstalk is corrected when it is determined as a result of the tracking polarity identification that a tracking control should be performed on the land track. Therefore, with an LTH disc which has a higher degree of groove modulation, it is possible to prevent a focus driving current from being generated due to an optical crosstalk component and prevent the focus control from being fluctuated due to optical crosstalk, and it is therefore possible to reduce the power consumption and improve the stability of the focus control, thereby improving the recording/reproduction performance of the optical disc apparatus.

Next, the timing with which the tracking polarity identification and the focus gain setting are performed during the start-up procedure of the optical disc apparatus 10 of the present embodiment will be described with reference to FIG. 17.

FIG. 17 is a flow chart showing how the tracking polarity identification and the focus gain setting are performed in the start-up procedure, wherein like steps to those shown in FIG. 16 are denoted by like reference numerals and will not be described repeatedly below.

First, in the apparatus start-up, steps S11 to S14 are performed. Where it is determined in step S14 that a tracking control is to be performed on the land track, the microcomputer 123 outputs a setting signal to the focus gain setting section 601 to lower the focus loop gain (S21). Then, step S18 is performed, thus completing the start-up.

Where it is determined in step S14 that a tracking control is to be performed on the groove track, the start-up is completed by performing step S18 without lowering the focus loop gain.

By such an operation as described above, it is possible to identify the type of a disc and to appropriately switch the polarity while in a state where the focus control is ON and the tracking control is OFF, upon the start-up of the optical disc apparatus 10. Therefore, it is possible to shorten the identification time and to thereby shorten the start-up time of the apparatus.

Moreover, the focus loop gain is lowered when it is determined as a result of the tracking polarity identification that a tracking control should be performed on the land track. Therefore, with an LTH disc which has a higher degree of groove modulation, it is possible to prevent a focus driving current from being generated due to an optical crosstalk component and prevent the focus control from being fluctuated due to optical crosstalk, and it is therefore possible to reduce the power consumption and improve the stability of the focus control, thereby improving the recording/reproduction performance of the optical disc apparatus.

Note that while a comparison is made between the FE signal amplitude when the tracking control is OFF and the FE signal amplitude when the tracking control is ON, to thereby obtain the leak-in level of the optical crosstalk leaking into the FE signal and set a gain for the multiplier 602 according to the level in the optical crosstalk correction method of the present embodiment, the optical crosstalk correction method is not limited to such a method.

Note that while the tracking polarity is identified, as in Embodiment 1, based on the phase relationship between the PPTE signal and the DPDTE signal when the light beam crosses a track in the present embodiment, a different identification method may be used.

Note that while the present embodiment employs a configuration where the focus loop gain is lowered when the tracking control is performed on the land track and the focus loop gain is kept unchanged when the tracking control is performed on the groove track, the following configuration may be employed. That is, the focus loop gain may be lowered in advance upon the optical disc start-up, wherein the focus loop gain is kept unchanged when the tracking control should be performed on the land track whereas the focus loop gain is raised when the tracking control should be performed on the groove track.

With such a configuration, the start-up of the apparatus is continued while the focus loop gain is kept low when it is determined as a result of the tracking polarity identification that a tracking control should be performed on the land track. Therefore, with an LTH disc which has a higher degree of groove modulation, it is possible to prevent a focus driving current from being generated due to an optical crosstalk component and prevent the focus control from being fluctuated due to optical crosstalk, and it is therefore possible to reduce the power consumption and improve the stability of the focus control, thereby improving the recording/reproduction performance of the optical disc apparatus.

### INDUSTRIAL APPLICABILITY

The optical disc apparatus of the present invention identifies the tracking polarity while in a state where the focus control is ON and the tracking control is OFF, and the present invention is therefore applicable as a technique for shortening the start-up time of the optical disc apparatus.

Moreover, for a disc which has a large amount of optical crosstalk, i.e., the tracking error signal leaking into the focus error signal, the optical disc apparatus of the present invention can, upon the apparatus start-up, identify such a disc and then appropriately correct the optical crosstalk or lower the focus gain. Therefore, the present invention is applicable as a technique that provides the effect of reducing the power consumption of the apparatus and improving the stability of the focus control, and improves the recording/reproduction performance of the optical disc apparatus.

### REFERENCE SIGNS LIST

100 optical head

101 light source

102 collimator lens

103 polarizing beam splitter

104 ¼ wave plate

105 object lens

106 optical disc

107 condenser lens

108 detector

109 focus actuator

110 tracking actuator

111 preamplifier

112 focus error (FE) signal generation section

114 focus control section

116 focus driving section

117 push-pull tracking error (PPTE) signal generation section

118 signal polarity switching section

119 tracking control section

120 switch

121 tracking driving section

122 phase difference tracking error (DPDTE) signal generation section

123 micro-computer (microcomputer)

1. An optical disc apparatus for recording and/or reproducing data to/from an information carrier where data is recorded on one of a groove track and a land track, comprising:
a light-receiving section for receiving reflected light from the information carrier;
a detection section for detecting, based on an output signal from the light-receiving section, a positional shift between a position where the information carrier is irradiated with a light beam and the track; and
an identification section for identifying a type of the information carrier as being either an information carrier where data is recorded or reproduced to/from a groove track or an information carrier where data is recorded or reproduced to/from a land track,
wherein the identification section identifies the type of the information carrier while in a state where a focus control is being performed and a tracking control is not being performed.

2. The optical disc apparatus of claim 1, wherein the identification section identifies the type of the information carrier based on a signal generated as the light beam crosses the track while in a state where the tracking control is not being performed.

3. The optical disc apparatus of claim 2, further comprising:
a focus error signal generation section for generating a focus error signal indicating a state of convergence of the light beam based on the output signal from the light-receiving section; and
a focus control section for outputting a signal for the focus control based on the focus error signal,
wherein the identification section identifies the type of the information carrier based on a magnitude of an amplitude of an output signal from the focus control section.

4. The optical disc apparatus of claim 2, wherein:
the detection section generates a push-pull tracking error signal and a differential phase ditection tracking error signal; and
the identification section identifies the type of the information carrier based on a phase relationship between the push-pull tracking error signal and the differential phase ditection tracking error signal.

5. The optical disc apparatus of claim 2, further comprising:
a focus error signal generation section for generating a focus error signal indicating a state of convergence of the light beam based on the output signal from the light-receiving section, wherein:
the detection section generates a differential phase ditection tracking error signal; and
the identification section identifies the type of the information carrier based on a phase relationship between a component of the focus error signal and the differential phase ditection tracking error signal.

6. The optical disc apparatus of claim 2, wherein:
the detection section generates a tracking error signal;
the optical disc apparatus further comprises:
a light amount detection section for detecting an amount of return light of the light beam based on the output signal from the light-receiving section; and
a normalization section for normalizing the tracking error signal with an output signal from the light amount detection section; and
the identification section identifies the type of the information carrier based on a magnitude of an amplitude of the normalized tracking error signal.

7. The optical disc apparatus of claim 1, further comprising:
a light amount detection section for detecting an amount of return light of the light beam based on the output signal from the light-receiving section,
wherein the identification section identifies the type of the information carrier based on a level of an output signal from the light amount detection section.

8. The optical disc apparatus of claim 1, further comprising:
a focus error signal generation section for generating a focus error signal indicating a state of convergence of the light beam based on the output signal from the light-receiving section;
a focus control section for outputting a signal for the focus control; and
a correction section for correcting an optical crosstalk contained in the focus error signal, wherein:
the correction section performs the correction based on an identification result of the identification section; and
the focus control section outputs a signal for the focus control based on the corrected focus error signal.

9. The optical disc apparatus of claim 1, further comprising:
a setting section for setting a focus loop gain for the focus control,
wherein if the identification section identifies the type of the information carrier as being an information carrier where data is recorded or reproduced to/from a land track, the setting section lowers the focus loop gain from that before the identification.

10. The optical disc apparatus of claim 1, further comprising:
a setting section for setting a focus loop gain for the focus control,
wherein if the identification section identifies the type of the information carrier as being an information carrier where data is recorded or reproduced to/from a groove track, the setting section raises the focus loop gain from that before the identification.

11. A method for driving an optical disc apparatus for recording and/or reproducing data to/from an information carrier where data is recorded on one of a groove track and a land track, the method comprising the steps of:
receiving reflected light from the information carrier;
detecting, based on a signal obtained by receiving the light, a positional shift between a position where the information carrier is irradiated with a light beam and the track; and
identifying a type of the information carrier as being either an information carrier where data is recorded or reproduced to/from a groove track or an information carrier where data is recorded or reproduced to/from a land track,
wherein the type of the information carrier is identified while in a state where a focus control is being performed and a tracking control is not being performed.

12. An integrated circuit for identifying a type of an information carrier, when provided in an optical disc apparatus for recording and/or reproducing data to/from the information carrier, the integrated circuit comprising:
a detection section for detecting a positional shift between a position where the information carrier is irradiated with a light beam and a track; and
an identification section for identifying a type of the information carrier as being either an information carrier where data is recorded or reproduced to/from a groove track or an information carrier where data is recorded or reproduced to/from a land track,
wherein the identification section identifies the type of the information carrier while in a state where a focus control is being performed and a tracking control is not being performed.
